(19) United States
(12) Patent Application Publication
(10) Pub. No.: US 2024/0123757 A1
(43) Pub. Date: Apr. 18, 2024

(54) LAMINATE WITH A DECORATIVE LAYER, COMPOSITE MADE UP OF A LAMINATE AND A MOLDING, AND METHOD FOR PRODUCING THE LAMINATE

(71) Applicant: PolyIC GmbH & Co. KG, Fürth (DE)

(72) Inventors: Wolfgang CLEMENS, Fürth (DE); Martin HAHN, Fürth (DE); Jörg STIERAND, Fürth (DE); Mathias GRUBER, Fürth (DE); Johannes SCHAD, Fürth (DE)

(21) Appl. No.: 18/277,610

(22) PCT Filed: Feb. 22, 2022
(86) PCT No.: PCT/EP2022/054363

§ 371 Date: Aug. 17, 2023

(30) Foreign Application Priority Data
Feb. 23, 2021 (DE) 10 2021 104 294.1

(51) Int. Cl. B44C 3/00; G02B 5/02

(52) U.S. Cl. CPC B44C 3/005; G02B 5/0242; G06F 3/041

(57) ABSTRACT

A laminate with a decorative layer over an electrical functional layer such as a touch sensor panel, which provides for example a touchpad functionality, as well as a production method for it. It is possible for the first time to perform an individualization of prefabricated laminates with functionality such as touch functionality of a touch sensor in an uncomplicated manner. This is achieved by supplementing a functional laminate with a laser protective layer between the electrical functional layer and a decorative layer which can be lasered and written on with simple measures.

The invention relates to a laminate with a decorative layer over an electrical functional layer such as a touch sensor panel, which provides for example a touchpad, slider, and/or other touch functionality, as well as a composite formed with this laminate with a molding such as a panel in a vehicle or on a machine and a production method for producing the laminate.

Decorative and/or functional laminates are known, such as represent, for example in the composite with moldings such as glass, metal and/or plastic panels, the operating elements— made with corresponding design— of the corresponding vehicles, means of communication, mobile phones, computers and/or machines, e.g. coffee machines, washing machines. The individualization and the installation of such a decorative laminate requires printing machines, which are not available everywhere. Placing the decorative laminate, which provides the items of information as well as the operating functionality, on the molding is usually effected without positional tolerance sufficient for mass production.

There is therefore the need to individualize decorative laminates, in particular the laminates with electrical functions such as LEDs, touch sensors, touch sensor panels, multi-touch screens, locally by the customers via simple measures— thus in an uncomplicated manner— after delivery has been effected by the manufacturer. In particular, there is also the need to provide a technique by which a composite of the laminate that can be individualized in an uncomplicated manner with the molding can be effected with positioning tolerances suitable for mass production. Up to now, these composites have been manufactured for example by back-injection molding.

The invention relates for example to the structure of HMIs, thus human-machine interface components, wherein according to the state of the art, in particular in the case of semitransparent decorations, such as e.g. made of semitransparent indium, smoked panels and/or semitransparent black paint, a good positioning and/or sharp symbols combined with electrically conductive functional layers—e.g. touch sensors—is/are difficult.

In particular in the case of deep-drawn, e.g. 3D molded, printed films, the problem arises that the printed symbols can be warped in the deep-drawing process, both the symbols themselves and the position of the symbol. In the subsequent back-injection molding, for example, a decorative film can be negatively affected. Particularly in combination with a metallic foil, such as for example with metallic, non-conductive indium, which is semitransparent, the desired mirror effect with symbols that can be shone through and at the same time an electrically conductive functional layer, for example a touch sensor, can result in a large number of rejects of unacceptable components in the case of mass production.

A decorative film in which a transparent laser protective varnish layer is arranged in the middle between two colored varnish layers is known from DE 10 2018 123473 A1.

A disadvantage of this is that it is expensive to place the second colored varnish layer and complex to place the laser protective varnish layer between two colored varnish layers.

The object of the present invention is correspondingly to create a laminate which can be marked and/or decorated in an individualized manner by simple means “end-of-line” before or after installation, in particular in the composite with a molding, by laser irradiation in process steps that are as simple as possible.

This object is achieved by the subject-matter of the present invention, as disclosed in the description and the claims.

Accordingly, a subject-matter of the present invention is a laminate with at least one electrically conductive functional layer, a decorative layer and laser protective layer that can be shone through, wherein the laser protective layer is arranged between decorative layer and electrically conductive functional layer such that it adjoins the electrically conductive functional layer without colored varnish layer lying in between. Moreover, a subject-matter of the invention is a composite of the laminate with a molding, wherein the laminate is arranged between a light source and the surface of the molding facing the observer.

Finally, a subject-matter of the present invention is a method for producing a laminate, comprising at least one electrically conductive functional layer, at least one decorative layer and at least one laser protective layer, wherein the laser protective layer is arranged between decorative layer and electrically conductive functional layer such that it adjoins the electrically conductive functional layer without colored varnish layer lying in between, and the method comprises the following steps, which are performed in particular in the following order:
a) providing an electrically conductive functional layer
b) applying at least one laser protective layer that can be shone through adjoining the electrically conductive functional layer without colored varnish layer lying in between, in particular by means of printing, coating, laminating, stamping and/or lining methods and/or by means of physical vapor deposition,
c) applying at least one decorative layer to the laser protective layer that can be shone through, in particular by means of printing, coating, laminating, stamping and/or lining methods and/or by means of physical vapor deposition, and d) removing one or more regions of the decorative layer by means of lasers.

A general finding of the invention is that a laminate, comprising a layer stack, with an electrically conductive functional layer which provides an electrical or electronic functionality, such as a touch sensor, a display, a multi-touch sensor, can be individualized, both “end-of-line” and locally by the customer after sale and delivery have been effected, and/or after installation in a plastic molded part, in an uncomplicated manner using a decorative layer which can be ablated and/or written on by means of lasers, if
firstly a suitable laser is used and
secondly there is a suitable layer structure.

The layer structure named here of decorative layer, laser protective layer and electrically conductive functional layer as a rule comprises more than three plies, because firstly each of the named layers can be constructed single- or multi-ply and secondly another one or more, identical or non-identical, plies of adhesive, primer, protective layers and any desired combinations of the above-named plies can be provided between the layers.

According to the present invention a laser protective layer is therefore provided between the decorative layer and the electrical functional layer such that the laser protective layer adjoins the electrically conductive functional layer without colored varnish layer lying in between. In addition, it is provided that a laser system with a wavelength of from 380 nm to 1400 nm is used for marking and/or decorating the decorative layer.

The molding is for example a glass, metal and/or plastic panel, such as are used in vehicle cockpits, machine operating panels and the like. The moldings according to the invention can also comprise any desired material combinations.

The composite of molding and laminate can e.g. be backlit and is e.g.
the cockpit and/or part of a cockpit, or respectively another functionalized interior, of a vehicle,
the plastic, metal and/or glass panel of a machine such as a coffee machine, a washing machine etc. and/or
the display of a means of communication such as a computer, a mobile phone, etc.

The “laser protective layer” provided here, which can be formed single-ply or multi-ply, is designed such that it scatters and/or deflects the laser beam possibly passing through the decorative layer such that it does not—completely—penetrate the laser protective layer and/or reduces its power density to such an extent that lower layers, in particular the electrically conductive functional layer(s), are not damaged. It is preferably provided that the scattering of the incident laser beam is already sufficient at the surface of the laser protective layer in order that the laser protective layer itself is also not damaged by a laser beam penetrating the decorative layer, neither through the complete layer thickness of the laser protective layer nor superficially.

According to an advantageous embodiment one or both surface(s) of the laser protective layer are structured, in particular light-scattering surface structures can be provided.

“Surface” in relation to the laminate and/or the molding denotes in each case the larger surface. In the case of a ply of a layer stack, this is in principle the one describing the surface forming the surface area, thus as a rule the extent in the x, y direction, not the one describing the surface forming the height, thus the extent in the z direction.

In addition, it is provided that a laser system with a wavelength of from 380 nm to 1400 nm is used for ablating, writing on and/or partially removing the decorative layer and thus for marking and/or decorating the decorative layer.

The laser protective layer is preferably arranged directly—thus adjoining the decorative layer—of course in some circumstances with corresponding intermediate plies for gluing and/or primers. The laser protective layer protects the underlying layers of the layer stack, in particular the electrically conductive functional layer, adjoining the laser protective layer without colored varnish layer lying in between, from mechanical, physical and/or chemical environmental influences, and above all from damage by laser radiation.

During the removal of one or more regions of the decorative layer by means of a laser, regions which represent images, patterns and/or alphanumeric characters are removed. These are e.g. logos, symbols, pictograms, figures, letters, words, numbers, digits. Due to the removal by means of lasers, these regions then become recognizable and/or readable for the observer.

The method step d) “removing by means of lasers” can be followed by and/or comprise another mechanical processing. The removal of the decorative layer can be effected entirely or partially. Here, the “partial” removal of regions of the decorative layer does not mean that the complete layer was stripped in the region, in the sense of a hole at that point in the layer and possibly damage of an underlying layer, but rather that only an indentation was made. Through the irradiation by means of lasers, a region of the decorative layer is for example—partially-vaporized, with the result that it is removed completely. Ablation by means of lasers can be done all through the decorative layer, or also only to a certain percentage of the layer thickness.

The laser protective layer has for example a layer thickness in the range between 0.5 μm and 1000 μm, preferably between 1 μm and 800 μm, preferably in the range of from 1 μm to 500 μm, in particular between 1 μm and 200 μm, preferably between 1 μm and 150 μm, e.g. in the range between 50 μm and 120 μm, particularly preferably between 75 μm and 100 μm.

A laser protective layer according to the invention can be formed single-ply—as an individual ply—or multi-ply—as a layer stack of several individual plies. The layer thicknesses and/or the materials of the individual plies of a laser protective layer can be identical or different. The laser protective layer can be present for example as a film or as a composite and/or laminate of several films. For example, a film which is part of the laser protective layer can also be present coated.

Likewise, films and/or individual plies which are parts of the laser protective layer can comprise identical or different fillers.

According to an advantageous embodiment the laser protective layer comprises at least one individual ply which particles which bring about the scattering of the light, in particular of a laser beam. The protection of the layers lying underneath the laser protective layer from damage by laser treatment is strengthened by a preferably homogeneous distribution of light-scattering particles within a ply.

As an alternative or supplement to light-scattering particles in the laser protective layer, bubbles, blisters and/or pores can also be provided there in at least one individual ply of the laser protective layer. Pores or bubbles can also serve as scattering centers and thus constitute the protective effect of the laser protective layer.

The laser protective layer, or respectively an individual ply of a laser protective layer, can comprise for example open and/or closed pores. Open pores are located on the surface of the ply and closed pores are embedded in the ply.

For this purpose, the laser protective layer advantageously comprises a matrix material, in particular a glass, such as a thin glass, and/or a carbon-based polymer. For example, the matrix material of the laser protective layer can comprise monomers, oligomers, polymers and/or copolymers, preferably made of compounds such as polymethyl methacrylate (PMMA), polyetherimide (PEI), polyacrylate, polyester (PE), polycarbonate (PC), polyamide (PA), polyethylene terephthalate (PET), polyoxymethylene (POM), polyimide (PI), polyurethane (PU), polysulfone, in particular poly(arylethersulfone) PAES and/or polyvinyl chloride (PVC), in each case individually and/or in any desired copolymers, mixtures, combinations and/or blends.

According to a further advantageous embodiment the laminate has a laser protective layer which has a transmittance of at least 25%, preferably of at least 75%, further preferably of at least 85%.

It is advantageous if the laser protective layer that can be shone through scatters transmitted light, in particular light in the wavelength range between 380 nm and 1400 nm, diffusely. This means that the laser protective layer that can be shone through has a haze value of at least 30 haze units, in particular of at least 50 haze units, preferably of at least 70 haze units and in particular preferably of at least 85 haze units.

The haze value is preferably determined in haze units in transmission according to the ASTM D 1003 standard. For example, the haze value is measured with the “BYK haze-gard i” meter from Byk-Gardener, Geretsried, Germany. Here, the layer or film to be measured is preferably held in the open sample compartment of the meter, and in particular for the haze value is placed on the so-called “haze port” of the device, wherein the measurement is advantageously carried out by means of standard illuminant D65. The result of the measurement is then preferably displayed on the meter's screen.

The haze value is advantageously given in percent (%). It is therefore possible for the unit of the haze value to be percent (%) in this case. The value range of the haze value is therefore preferably 0-100%. It is thus possible for the haze units to be percentage values or for the haze units to represent percentage values. The maximum value is preferably 100%. Values higher than 100% possibly occurring can be caused for example, in particular depending on the measurement principle used, by additional scattered light effects and/or reflection effects during the measurement.

By haze is preferably meant here a diffuse scattering, in particular large-angle scattering, which leads in particular to a decrease in the imaging quality. Particles or inhomogeneities in the material, at which in particular the light is scattered in all spatial directions, preferably act as scattering centers, wherein advantageously only a low scattering intensity falls on each solid angle. In particular, a reduction in the contrast, a diffuse image and/or a milky-cloudy appearance is hereby brought about, wherein this effect is preferably called haze or cloudiness. Thus, the haze value preferably represents a measure of the cloudiness of samples that are transparent and/or can be shone through, for example of plastic layers and/or films.

It is further possible for the laser protective layer that can be shone through, thus is partially translucent, to have for example an appearance that is milky-cloudy and/or can be shone through and to deflect more than 30%, preferably more than 50%, further preferably more than 70%, in particular preferably of more than 85%, of the transmitted light, in particular from the wavelength range between 380 nm and 1400 nm, by more than 2.5° from the direction of the incident light beam.

This makes it possible for light transmitted through the laser protective layer that can be shone through to be scattered diffusely, preferably in a large solid angle range, further preferably in all spatial directions, with the result that light, in particular of a point light source, is scattered homogeneously, with the result that the laser protective layer that can be shone through appears to be homogeneously illuminated to an observer, in particular despite being illuminated with a point light source.

It is also possible for the laser protective layer that can be shone through to be dyed, in particular for the laser protective layer that can be shone through to be dyed by means of dyes and/or pigments. Preferably, the pigmentation level of the laser protective layer that can be shone through is less than 15%, preferably less than 10%, further preferably less than 5%. In particular, this makes it possible for the laser protective layer that can be shone through in conjunction with layers arranged underneath the laser protective layer that can be shone through, in particular in conjunction with the at least one metallized electrically conductive functional layer, to generate a specific optical impression, such as for example a color mixing effect.

Here, the pigmentation level reveals nothing about the quantity of other particles present.

The laser protective layer advantageously protects underlying layers of the laminate not only from damage by targeted laser irradiation, but also from mechanical, physical and/or chemical environmental influences.

Preferably, the decorative layer is formed opaque and/or the decorative layer has, in particular in the wavelength range between 380 nm and 1400 nm, a transmittance of at most 50%, preferably of at most 20%, further preferably of at most 5%. It is hereby achieved that the decorative layer, in particular when observed from the side, generates a dark optical impression, in particular which provides a background that appears dark with regard to a possible backlighting. In particular, a particularly high contrast between the backlighting and this background can thereby be achieved and the backlighting can be perceived sufficiently well even at low backlighting luminous intensities.

The decorative layer preferably has a layer thickness of between 0.1 μm and 50 μm, preferably between 0.3 μm and 30 μm, in particular preferably a layer thickness of from 0.5 μm to 17 μm, for example of 7 μm. As a result, the required opacity of the decorative layer on the one hand and the production of a thin and optionally flexible laminate on the other hand can be ensured.

It is further possible for the decorative layer to be multi-layered, in particular for the decorative layer to be formed from two or more sublayers, wherein the two or more sublayers preferably in each case have a layer thickness of between 0.1 μm and 50 μm, further preferably between 0.5 μm and 5.0 μm. The sublayers can have identical or different transparency, color and layer thickness.

It is advantageous in particular if the sublayers have different colors, in particular from the RGB color space or the CMYK color space.

By color is meant here in particular a color dot which can be represented in a color model such as e.g. the RGB color model (R=red; G=green; B=blue) or the CMYK color model (C=cyan; M=magenta; Y=yellow; K=black) within the color space.

It is also advantageous if the decorative layer is dyed, in particular if the decorative layer is dyed by means of dyes and/or pigments. Preferably, the pigmentation level of the decorative layer is between 5% and 35%, preferably between 20% and 25%. It is desirable that the dyeing of the decorative layer is as covering as possible, among other things in order that the structures under the decorative layer disrupts the visual appearance for the user as little as possible. Where possible, therefore, dyes with a high covering power are chosen for dyeing the decorative layer. However, covering pigments often contain graphite particles and/or other electrically conductive particles. The electrical conductivity that can be generated thereby in the decorative layer, however, disrupts the functionality of the electrically conductive functional layer within the laminate. The choice of the pigments of the decorative layer in the voltage field is therefore made between covering power of the color shade and minimization of the electrically conductive colored particle content.

For example, in the case of the use of a touch function by the electrically conductive functional layer in the laminate it is advantageous if the decorative layer is not electrically conductive and thus does not influence the capacitive touch sensitivity. The electrical sheet resistance of the decorative layer is to be greater than 1 megaohm per square, advantageously greater than 10 megaohms per square and in particular advantageously greater than 50 megaohms per square.

According to a further advantageous embodiment the at least one decorative layer comprises a monomer, oligomer and/or polymer, in particular polyethylene terephthalate (PET), polymethyl methacrylate (PMMA), polyethylene naphthalate (PEN), acrylate, polyamide (PA), and/or acrylonitrile butadiene styrene copolymer (ABS), in each case present individually and/or in any desired copolymers, mixtures, combinations and/or blends.

According to a further embodiment the at least one decorative layer can be a graphite and/or metal layer, in particular an optically dense metal layer. For example, metals such as aluminum, cobalt, copper, gold, iron, chromium, nickel, silver, platinum, palladium, indium and/or titanium, as well as any desired alloys and/or pastes of the above-named metals, can be used for this.

According to a further embodiment of the laminate the decorative layer which faces the observer can comprise a polymeric material, as described above, which is filled with fillers and/or pigments.

The laminate comprises an electrical functional layer, which can also be formed single- or multi-ply. The electrically conductive functional layer can be present for example as a film composite.

The possible layer thicknesses of the electrically conductive functional layer approximately correspond for example to those of the laser protective layer, thus lie in the range between 0.5 μm and 1000 μm, preferably between 1 μm and 500 μm, preferably the layer thickness lies in the range of from 50 μm to 250 μm, for example between 1 μm and 200 μm, in particular preferably between 10 μm and 150 μm, e.g. in the range between 75 μm and 100 μm.

The electrically conductive functional layer comprises for example at least one individual ply and/or a film of metal mesh. This is an electrical functional layer which has conductive, non-transparent traces with a thickness—thus extent in the z direction in the case of a two-dimensional functional layer the surface area of which extends along the x-y direction in space—in the range of from 2 nm to 5 μm, arranged forming a pattern parallel to the surface of a transparent carrier such that a conductive trace spacing which guarantees extensive conductivity of the electrical functional layer with at the same time transparency for the human eye is realized in the pattern.

The conductive, non-transparent traces in the so-called metal mesh have a width of up to 300 μm.

The electrical functional layer can, according to another embodiment, also comprise a transparent carrier ply, for example in the form of a film or a coated film or a film composite, on which non-transparent electrical conductive traces—for example as feed lines which can in turn be accommodated for example in an edge region, which is not necessarily transparent—with a greater size of the conductive trace, thus e.g. with a thickness of up to 20 μm, e.g. in the range of from 4 to 14 μm in the z direction, and a width in the x and y direction of up to 500 μm, are provided.

According to an advantageous embodiment of the laminate the electrical functional layer represents an electrode.

According to an advantageous embodiment the electrical functional layer has electrically conductive functional material on, underneath and/or in a carrier layer.

According to an advantageous embodiment the electrical functional layer comprises thin metal layers, in particular made of silver, copper, aluminum, gold, nickel, as well as any desired alloys thereof, as well as conductive silver, nanosilver, carbon-based conductive material, such as in particular carbon black, carbon nanotubes (CNTs), silver nanowires (AgNWs), conductive oxide layers, in particular indium tin oxide (ITO), conductive polymers, in particular PEDOT:PSS, alone or in any desired mixtures and/or combinations on and/or under a carrier layer and/or embedded in a carrier layer.

According to an advantageous embodiment the at least one functional layer forms at least one touch sensor panel, which comprises for example at least one input functionality, such as e.g. an audio control, gesture control, touch panel functionality, touchpad, in particular as a multi- or single-touch and/or at least one slider function and/or at least one rotary knob function, all above-named possibilities individually or in any desired combination.

A subject-matter of the invention is in addition a composite of the laminate and a molding, wherein the laminate is arranged between the surface of the molding facing a user and at least one light source.

The composite is formed by gluing, laminating, welding, soldering, fusion, mechanical fixing such as clamping, plugging, clipping together and/or combinations of the named techniques and/or other known techniques. For this purpose, a connecting material in the form of a corresponding coating and/or film applied over the whole surface or partially can be provided on the molding and/or on the laminate in each case superficially.

The molding has a surface which faces the user on one side, and a region to which the laminate can be fixed and which is as a rule opposite the surface facing the user.

The molding can be shone through at least in regions, in particular it has both regions that can be shone through and regions that cannot be shone through.

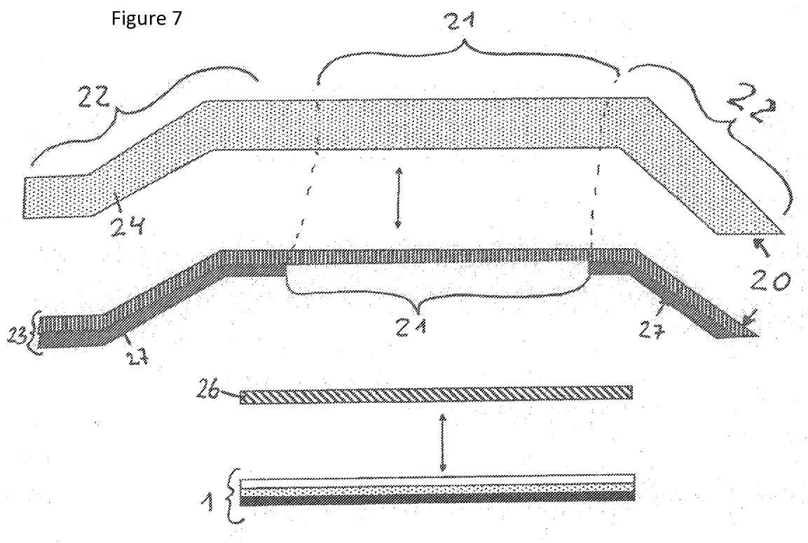

The molding comprises for example a plastic part which comprises the surface which faces the user. The plastic part can be produced for example by injection molding. The injection-molded component, e.g. the plastic component 24 of FIGS. 7 to 15, can be made of a wide variety of materials, such as
polycarbonate “PC”,
acrylonitrile/butadiene/styrene “PC-ABS”,
polymethyl methacrylate “PMMA”,
polyurethane “PUR”,
polyurethane “PUR”, flooded.

These materials can be used in any desired mixtures, blends and/or as copolymers for constructing the plastic component.

According to another embodiment the element 24 of FIGS. 7 to 15 is for example made of glass and/or inorganic, in particular ceramic, material.

The injection-molded component can furthermore, according to an advantageous embodiment of the molding, be coated and/or overvarnished and/or be provided with IMD topcoat.

As an alternative or supplement the molding comprises for example a film element, which is provided for example with decoration, e.g. indium.

The film element is preferably made of polycarbonate PC, and on that an electrically non-conductive semitransparent layer such as e.g. black varnish and/or indium as metallic, non-conductive layer.

The light source comprises for example one or more LEDs. The light source backlights, as needed, the molding, which has a sufficiently transparent quality at least at that point, wherein the laminate can likewise be shone through and—again for example—at least partially fulfills the display function on the one hand and/or the operating function on the other hand.

A subject-matter of the invention is also a method for producing a laminate, in particular a laminate according to the invention, comprising at least one electrically conductive functional layer, at least one decorative layer and at least one laser protective layer that can be shone through, wherein the laser protective layer is arranged between decorative layer and electrically conductive functional layer, wherein the method comprises the following steps, which are performed in particular in the following order:
a) providing an electrically conductive functional layer
b) applying at least one laser protective layer that can be shone through without colored varnish layer lying in between, and adjoining the electrically conductive functional layer, in particular by means of printing, coating, laminating, stamping and/or lining methods and/or by means of physical vapor deposition,
c) applying at least one decorative layer to the laser protective layer that can be shone through, in particular by means of printing, coating, laminating, stamping and/or lining methods and/or by means of physical vapor deposition, and
d) removing one or more regions of the decorative layer by means of a laser.

According to an advantageous embodiment of the method the method step of removing one or more regions of the decorative layer by means of a laser is carried out such that the removal of the decorative layer is effected only partially.

In particular, the method for altering the optical appearance of the decorative layer of a laminate by means of laser radiation is preceded by the following considerations:
1. determining a minimum laser intensity at which a target optical appearance of the decorative layer can just barely be achieved when the laser radiation is radiated onto the decorative layer;
2. determining a maximum laser intensity at which the functional layer just barely does not alter its function when the laser radiation is radiated onto the decorative layer;
3. selecting a writing laser intensity from the range formed by the minimum and maximum laser intensity;
4. radiating laser radiation onto the decorative layer at the writing laser intensity.

As soon as these considerations have been effected, a laminate with a laser protective layer under the decorative layer can be individualized locally and end-of-line with simple tools.

In particular, in the case of the use of a laser system with wavelengths of 380-1400 nm the decorative layer can be processed within a very wide process window. The underlying functional layer suffers no damage in the process. This would not be possible without the laser protective layer.

Through the use of the laser protective layer it is possible for a very wide process window of power (watts), frequency (Hz) and speed of the laser to be usable here, without having to fear damage to the laminate, in particular the functional, in particular electrically conductive, layers.

According to an advantageous embodiment of the method a laser, in particular a fiber laser, is used in step d), which emits coherent light, preferably from the visible range, thus in the range of from 380 nm to 780 nm, or infrared range, further preferably light from the wavelength range between 780 nm and 1400 nm, still further preferably light with a wavelength of 1064 nm.

For example, the following laser types can be used successfully here: ytterbium fiber laser; diode laser; fiber-coupled diode laser; neodymium-doped yttrium aluminum garnet—“Nd:YAG”—laser.

According to an advantageous embodiment of the method, step d) is carried out with a laser power of between 0.05 W and 1000 W, preferably between 1 W and 500 W, further preferably between 5 W and 200 W.

According to an advantageous embodiment of the method, in step d) at least one region is removed which represents a logo and/or a pattern and/or a symbol and/or an alphanumeric character.

According to an advantageous embodiment of the method, in step d) a laser is operated at a writing speed of at most 80000 mm/s, preferably at a writing speed of between 500 mm/s and 10000 mm/s, and/or the laser is operated at a pulse frequency of between 1 Hz and 10000 kHz, preferably between 1 kHz and 100 kHz.

The invention is explained in more detail below with reference to figures, which show example embodiments of the invention:

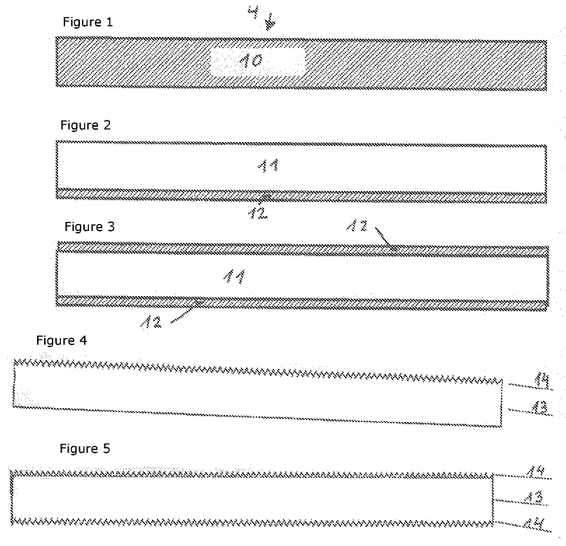

FIGS. 1 to 5 show example embodiments of the laser protective layer:

FIG. 1 shows a plastic film with scattering centers,

FIG. 2 shows a two-ply structure of a laser protective layer,

FIG. 3 shows a further multi-ply structure of a laser protective layer

FIG. 4 shows a laser protective layer structured superficially on one side and

FIG. 5 shows a laser protective layer structured superficially on both sides.

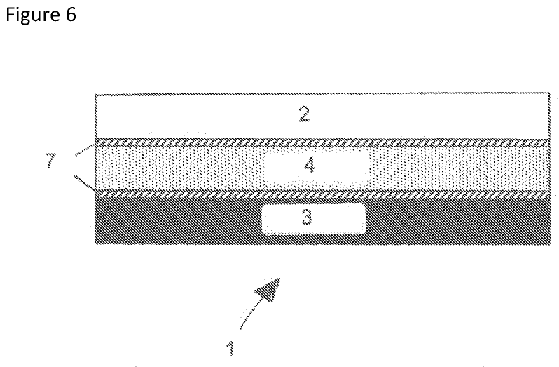

FIG. 6 shows the schematic structure of an embodiment example of a laminate

FIG. 7 shows an embodiment example of the individual elements arranged in the installation direction for forming a composite of a laminate and a molding

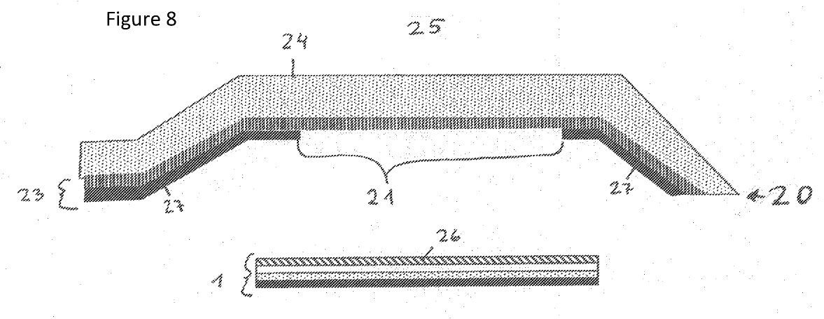

FIG. 8 shows an example preparation of the individual elements from FIG. 7 for forming the composite of laminate and molding

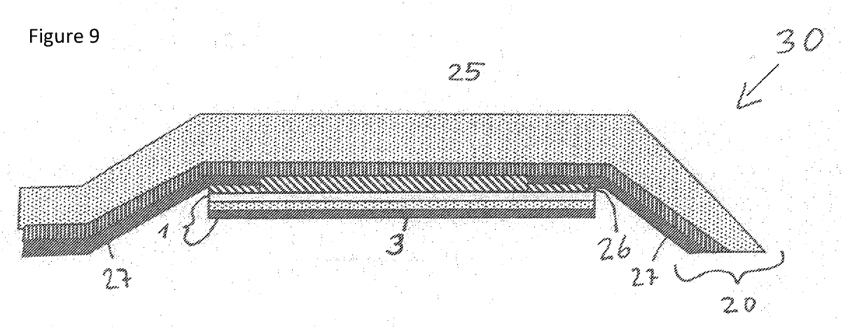

FIG. 9 shows the example composite of laminate and moldings formed from the individual elements of FIGS. 7 and 8

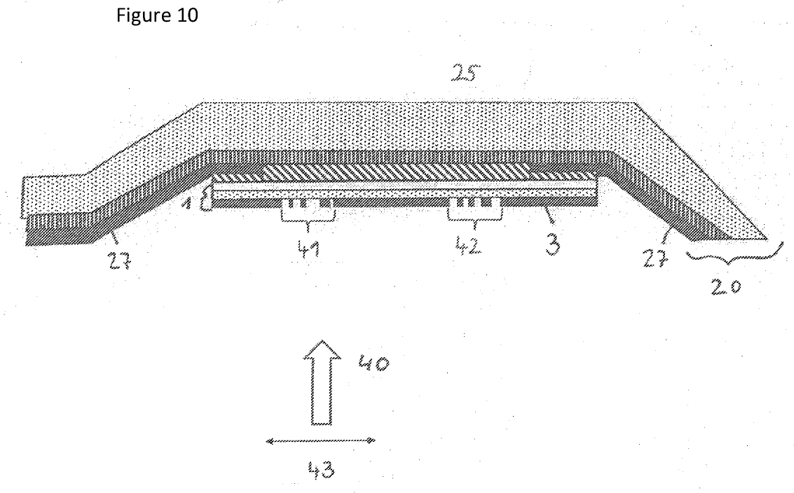

FIG. 10 shows the diagram of an individualization of the composite of laminate and molding by laser irradiation, for example at the customer's premises

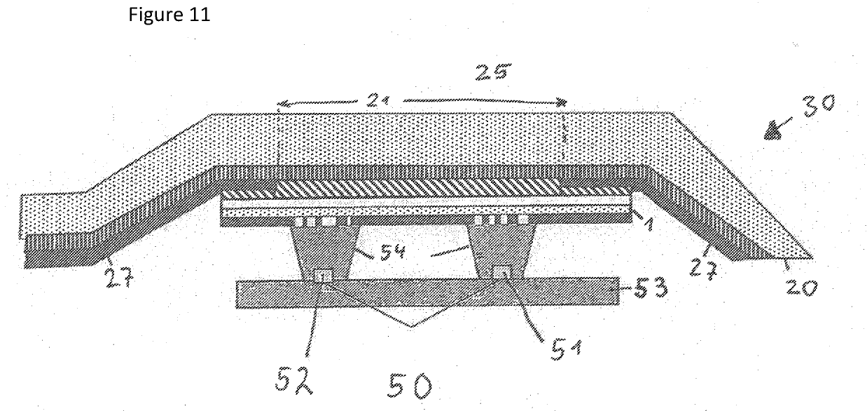

FIG. 11 shows an embodiment example of a composite of individualized laminate and molding with backlighting

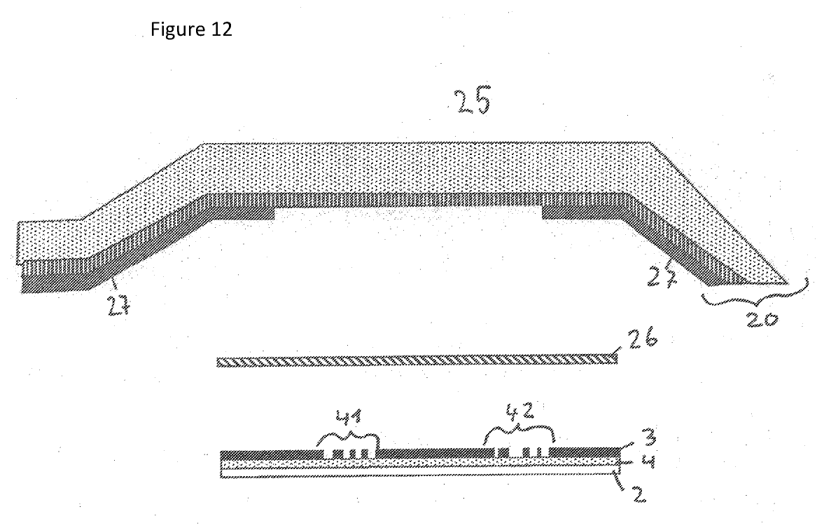

FIG. 12 shows another embodiment example of the individual elements arranged in the installation direction for forming a composite of a laminate and a molding

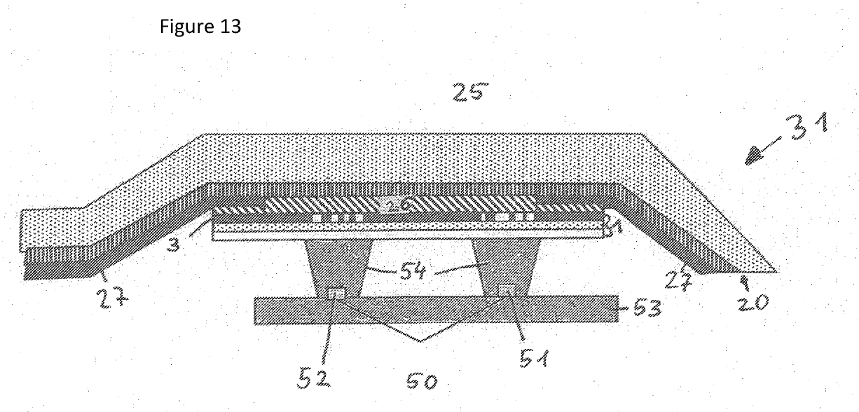

FIG. 13 shows a further embodiment example of a composite of laminate and molding formed from the individual elements of FIG. 12 with backlighting

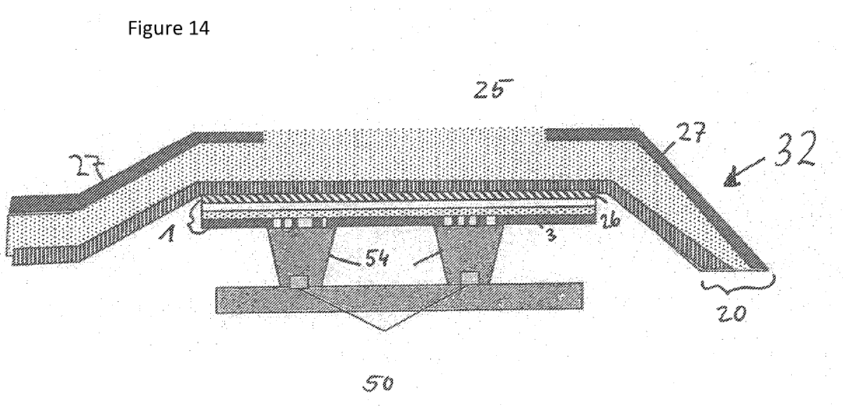

FIG. 14 shows a further embodiment example of a composite of a laminate and a molding, and finally

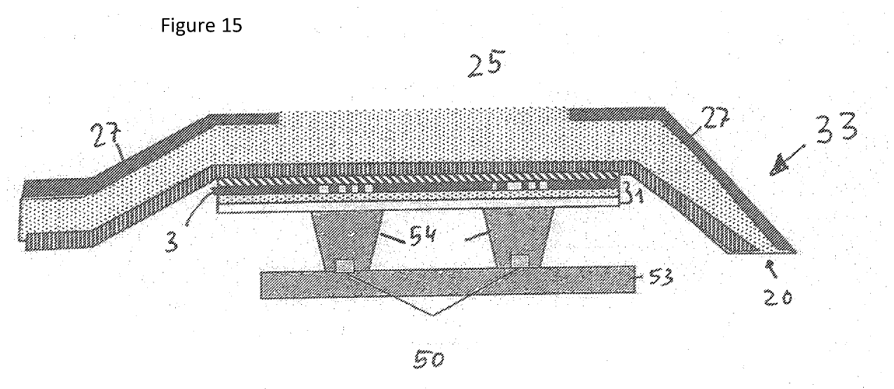

FIG. 15 shows a further embodiment example of a composite of a laminate and a molding.

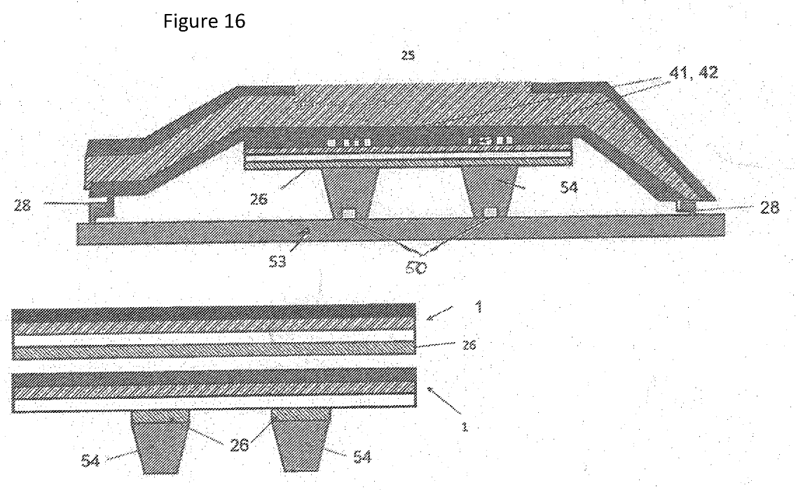

FIG. 16 shows a further embodiment example in which the composite of laminate and molding is formed mechanically at least in part

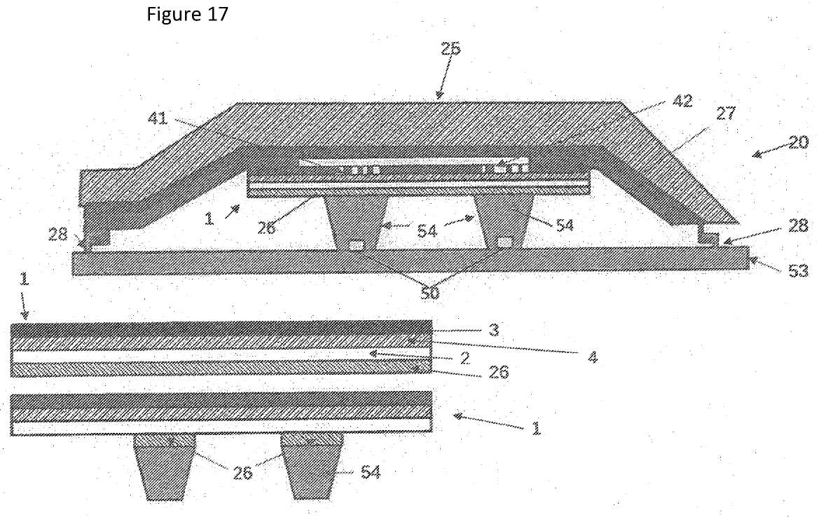

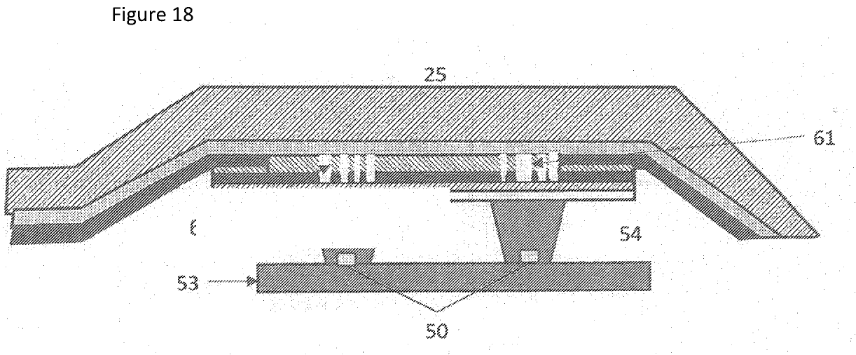

FIG. 17 shows a further embodiment example in which the laminate is pressed against the molding and in which the decorative layer is located on the underside of the molding

FIG. 18 shows a further embodiment example of FIG. 13 in which the primer/adhesive layer is laser-structured together with the decorative layer

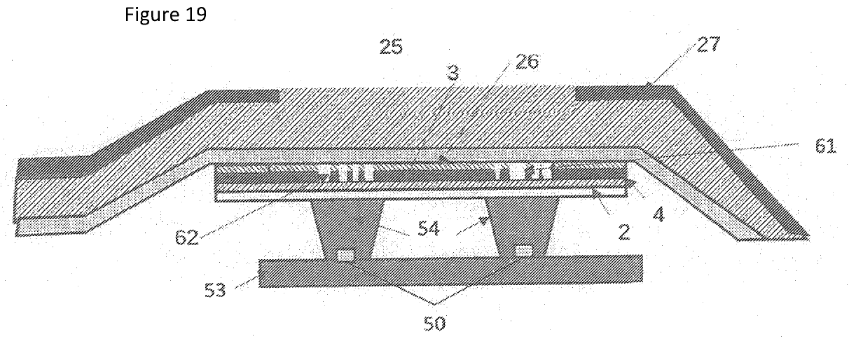

FIG. 19 shows a further embodiment example of FIG. 15 in which the primer and/or adhesive layer is laser-structured together with the decorative layer 3.

FIG. 1 shows, as an example embodiment of the laser protective layer 4, a transparent film 10, in particular a glass or plastic film, with embedded scattering effect. The film 10 can be formed one or multi-ply and—as indicated by the hatching—has light-scattering elements embedded, for example light-scattering particles and/or pores. The film 10 is deposited and/or applied for example directly on and/or to an electrically conductive functional layer, such as is part of the laminate—see FIGS. 6 to 15.

FIG. 2 shows another example embodiment of the laser protective layer 4 with a transparent substrate, and/or carrier film 11, which is coated on one side with a coating with scattering centers 12, for example a varnish layer which comprises light-scattering particles and/or pores.

FIG. 3 shows an embodiment example of a laser protective layer 4, in which a coating with scattering centers 12, which is for example a varnish layer and which comprises scattering centers, for example in the form of light-scattering particles and/or pores, is applied to the transparent substrate—and/or carrier film 11—on both sides.

FIG. 4 shows a further embodiment of the laser protective layer 4, in which a structuring 14 is applied to the surface on one side of a carrying ply 13. The ply 13 can be formed as one or more transparent substrates, and/or carrier films 11, and/or as a transparent film 10. The carrying ply 13 can furthermore be formed single- or multi-ply.

FIG. 5 shows superficial structuring 14 of the carrying ply 13 on both sides. The structuring 14 can be uniform, forming a pattern, but also statistical and/or random. The structuring 14 can be identical or different on both sides 14 of the carrying ply 13.

FIG. 6 shows a laminate 1, comprising a decorative layer 3—represented completely black—because still untreated, in particular not written on—an electrical functional layer 2 and, in between, a laser protective layer 4. The decorative layer 3 can be formed for example as a black, lightproof ply. A connecting material 7 is preferably located between the decorative layer 3 and the laser protective layer 4, as well as between the laser protective layer 4 and the electrically conductive functional layer 2. The connecting material can be adhesive, primer, protective layer and/or a combination of different materials, such as are used in a manner customary in the art for forming such laminates.

FIG. 7 shows example individual elements in the position of their intended connection for forming the composite of a laminate 1 and a molding 20.

From the bottom up, the laminate 1, as known from FIG. 6, is to be seen first, with decorative layer 3, laser protective layer 4 and electrically conductive functional layer 2.

The laminate 1 is followed, according to this embodiment, with a double arrow 20 towards the laminate 1, by the connection layer 26, which comprises one or plies of adhesive and/or primer such as e.g.
primer for functional foil bonding “FFB”,
primer for in-mold labeling “IML”,
transparent adhesive in the form of optical clear adhesive for laminating,
adhesive in the form of pressure sensitive adhesive for laminating and/or
primer for in-mold electronics “IME”,
as well as, where appropriate,
protective varnish layer(s), and which approximately correspond in terms of its dimensions to those of the laminate 1. The composite can, however, also be effected without connecting material and by simple mechanical fixing to the molding, such as for example hooking-in, clipping, clamping of the laminate 1—for example by fixing of the laminate 1 to a component for backlighting, which for its part has a sufficient mechanical strength for a clamping.

Above that and at a distance, the molding 20 is represented in two individual parts 23 and 24. The individual part 23 comprises the frame element 27 in the embodiment shown here. In the case of the molding 20—as represented here—this frame element 27 defines a region 21 that can be shone through, which is translucent and/or is sufficiently transparent for backlit elements to be recognized, and a non-transparent region 22 that cannot be shone through. The region 22 that cannot be shone through is defined by the frame element 27, which also delimits the region 21 that can be shone through.

The structure of the molding 20 is as desired and different depending on the application. The requirements placed on coffee machine operating panels here are different from those placed on sports car cockpits.

The two individual parts 23 and 24, as shown here, are assembled to form the molding 20. For example, the individual part 23 is a film element with or without decoration and the individual part 24 is a solid—for example 3D molded, injection-molded, printed or deep-drawn—plastic molded part and/or film element, which can virtually form a carrier. As indicated by the upper double arrow of FIG. 7, the two individual parts 23 and 24 are connected to form the molding 20. The two individual parts 23 and 24 can be arranged in any desired order, with the result that according to another embodiment one side of the film element 23 forms the surface 25 which faces the user.

The molding 20 shown in FIGS. 7 to 11 thus comprises a solid part 24 showing a surface 25 to the user, with a region 21 that can be shone through and is therefore transparent at least in part, behind which the laminate 1 for forming the composite can be glued by means of a connection layer 26 of adhesive, protective varnish layer(s) and/or primer.

For this, FIG. 8 shows the next production step, in which the laminate 1 with a corresponding connection layer 26 and the molding 20 with correspondingly dimensioned region 21 that can be shone through are present prepared for forming the composite of laminate and molding.

According to an advantageous embodiment the laminate 1 overhangs, at least on one side, the region 21 of the molding 20 that can be shone through, as represented in FIGS. 7 to 15.

FIG. 9 shows the composite 30 of laminate 1 and molding 20 with connection layer 26. The composite 30 has a surface 25 showing to the user. This composite has not yet been individualized by laser irradiation of the decorative layer, as can be seen on the continuously black decorative layer 3 of the laminate 1.

Finally, FIG. 10 shows the individualized and/or written-on composite, such as can be produced “end-of-line” or at the customer's premises. For this purpose, as represented by the arrow 40, which represents a laser beam, due to the movement of a laser beam 40 along the directions of the double arrow 43 from the decorative layer 3 of the laminate 1, regions 41 and 42 are uncovered, which in the case of backlighting (not shown) show themselves to the user differently on the side of the surface 25 from the regions of the decorative layer 3 which is over the whole surface and not lasered. These uncovered regions 41 and 42, which lie within the region 21 of the composite 30 that can be shone through, represent for example the symbol and/or display regions in the finished product.

This structure makes it possible for the regions of the composite that can be shone through 21, 41 and 42, the symbols and display surfaces to be able to be generated subsequently to the installation. The positional accuracy during the installation of the individual parts relative to the composite 30 plays no role here, because large tolerance ranges are provided in the region 21 of the composite that can be shone through. Through the lasering 40 of the uncovered regions 41 and 42 after the formation of the composite 30, as accurate as possible a positioning of the regions 41 and 42, as well as sharp imaging by the laser, can be achieved.

For example, it can be provided in a subsequent process step that the uncovered regions 41 and 42 are also highlighted with ink. The ink can be applied for example via digital printing and/or pad printing.

Furthermore, it can be provided that the composite also comprises a protective varnish on one or more sides.

FIG. 11 shows the composite 30 of laminate 1 and molding 20 according to the embodiment example of the individual parts shown in FIGS. 7 to 10 with backlighting by a light source 50. This light source can for example comprise one or more LEDs 51 and 52, which—again for example—are arranged on an electronics board 53. On the side of the surface 25 of the composite the writing which is generated by the laser treatment according to FIG. 10 and through which the backlighting of the LEDs 51, 52 emits along the light shafts 54 through the layers shows to the observer through the transparent region 21.

FIG. 12 shows, comparable to FIG. 8 of the embodiment example shown there, another embodiment example, in which the laminate 1 with another layer sequence, with the result that the electrically conductive functional layer 2 forms the bottommost layer ply. The laser protective layer 4 is arranged directly adjoining the electrically conductive functional layer 2, and on that the decorative layer 3, which is present already lasered, thus individualized and/or written on, in the embodiment example shown here.

The lasering 40 before the composite 31 is formed brings the advantage that the uncovered regions 41, 42 in the composite appear clearer and/or with optimum contrast for the user on the side of the surface 25 in the case of backlighting.

A connection layer 26, which again comprises adhesive, protective varnish layer and/or primer, comes onto the decorative layer 3 with the lasered and uncovered regions 41 and 42. After the connection layer 26 has been applied to the lasered decorative layer 3, the laminate 1 is connected to the molding 20.

The size of the regions 41 and 42 uncovered by lasers 40 is variable depending on the application, but in the embodiment example shown in FIG. 12 can no longer be altered after installation without disassembling the laminate 1.

The composite 31 of laminate 1 and molding 20 according to FIG. 13 differs from the composite 30 of FIG. 11 in that the lasered decorative layer 3 with uncovered regions 41 and 42 directly adjoins the molding 20 via a connection layer 26 lying thereon and still cannot be written on by laser irradiation 40 in the composite.

FIG. 14 shows a composite 32 which differs from the two previously shown composites 30 and 31 from FIGS. 11 and 13 in that the frame element 27, which cannot be shone through, of the molding 20, which separates the transparent region 21 that can be shone through from the non-transparent region 22 that cannot be shone through, is arranged on the outside of the surface 25 of the molding 20. The structure according to FIG. 14 otherwise corresponds to that known from FIG. 11.

Finally, FIG. 15 shows the composite 33, which in terms of the structure of the molding 20 corresponds to that from FIG. 14, but underneath that shows the composite according to FIG. 13, with the laser marking of the decorative layer 3 of the laminate 1 carried out before the installation.

After the composite 30, 31, 32 and 33 has been formed, different downstream process steps, such as overvarnishing, can still be realized for example until the product has been finished. For example, further components, which can be optical, electrical and/or mechanical components, are provided adjoining the laminate. The electrically conductive functional layer preferably has contacts and/or connectors, which are not necessarily designed able to be shone through.

FIG. 16 shows a structure corresponding to FIG. 15, thus with the frame element 27 on the outside of the composite of laminate 1 and molding 20, with the difference from FIG. 15 that the laminate 1 is pressed onto the molding 20 by means of mechanical pressure by the two snap hooks with detents 28. For this purpose, the laminate 1 is applied to one or more light shafts 54, which are fixed to the electronics board 53, by means of an adhesive and/or primer system, for example comprising the connection layer 26. The electronics board 53 for its part is mechanically connected to the film body 20 via detents and snap hooks 28. The upper part of FIG. 16 again shows the composite of molding 20 and laminate 1. The lower part of FIG. 16 shows the two variants, one being the large-area depositing of the connection layer 26 and under that the depositing of the connection layer 26 in regions.

The connection layer 26, which is in particular an adhesive and/or primer layer, can be applied to the laminate 1 over the whole surface or only partially, thus entirely or only in regions, e.g. in the regions adjoining the light shaft 54, as shown in the lower region of FIG. 16.

FIG. 17—upper representation of a composite 31 corresponding to FIG. 13 —shows the principle of the connection like FIG. 16, in particular by mechanical means such as the snap hooks with detents 28. Here, the layer element 1 is again coupled to the electronics board 53, which forms the composite of molding 20, light source 50 and laminate 1 via the mechanical fixing to the molding 20, via the gluing to the light shafts 54. The light source 50 here comprises for example two LEDs 51, 52, the electronics board 53 as well as the light shafts 54. The laminate 1 comprises, as represented in FIG. 6, at least one decorative layer 3, a laser protective layer 4 and an electrically conductive functional layer 2. The molding 20 comprises a region 21 that can be shone through, a region 22 that cannot be shone through, a frame element 27, a, for example flexible, film element 23 as part of the molding 20, a solid plastic component 24, which provides the surface 25 towards the user and in the embodiment example shown in the present case also either the detents or the snap hooks 28 for forming the mechanical attachment of the electronics board 53 —equipped among other things with the laminate 1—to the molding 20.

The connection layer 26 for connecting the electronics board 53 to the laminate 1, for example an adhesive and/or primer layer, on the laminate 1, can again be applied over the whole surface or only partially—in particular to the regions of the light shafts 54.

FIG. 18 shows a further embodiment example according to FIG. 13, in which the primer/adhesive layer is laser-structured together with the decorative layer. The uncovered regions 61 and 62 thereby extend vertically over several plies, in contrast to the regions 41 and 42 of FIGS. 10 to 17, which extend vertically, thus in the z direction, only through the decorative layer 3.

FIG. 19 shows a further embodiment example of FIG. 15, in which the primer/adhesive layer is laser-structured together with the decorative layer. The uncovered regions 41 and 42 thereby extend vertically over several plies.

Each of the shown layers 2 and the laser protective layer 4 can for their part be present in several layers or plies.

Underneath the electrical functional layer 2, one or more carrier layer(s) and/or one or more protective layer(s) can be provided for constructing the electrical function of the laminate. The structure of a laminate with electrically conductive functional layer without laser protective layer and decorative layer according to the present invention is known for example from other published documents by the applicant, such as WO 2012/048840 and WO 2015/104295.

An adhesive can be provided between the layers of the laminate and on top of and/or underneath the laser protective layer.

Carrier layers here can have layer thicknesses in the range of from 50 μm to 250 μm, in particular in the range of from 60 μm to 90 μm.

Adhesive layers can for example have layer thicknesses in the range of from 1 μm to 250 μm, in particular from 5 μm to 100 μm.

It is possible to focus the laser beam for carrying out method step d) by means of one or more lenses. In particular, lenses with a focal length of between 35 mm and 800 mm, preferably between 200 mm and 500 mm, further preferably of 254 mm, can be used here.

It is further preferred if a laser, in particular a fiber laser, is used in step d), wherein the laser emits coherent light, preferably from the visible or infrared range, preferably from the near-infrared range, further preferably light from the wavelength range between 780 nm and 1400 nm, still further preferably light with a wavelength of 1064 nm.

Preferably, the laser power in step d) is between 0.05 W and 1000 W, preferably between 1 W and 500 W, further preferably between 5 W and 200 W.

It is expedient if the laser beam is deflected by means of movable mirrors, in particular by means of a laser scanning module, along the one or more first regions in step d).

According to a further embodiment example of the invention the laser is operated at a writing speed of at most 80000 mm/s, preferably at a writing speed of between 500 mm/s and 10000 mm/s, and/or the laser is operated at a pulse frequency of between 1 Hz and 10000 kHz, preferably between 1 kHz and 1000 kHz.

However, it is further also possible for the laser to be operated continuously.

In the present case, “that can be shone through means in particular a high transmittance, e.g. of 70% or more, in the wavelength range of from 380 nm to 1400 nm.

“Translucency” also means a high transmittance in the wavelength range of from 380 nm to 1400 nm, which is perceived by the observer not as image-preserving, but as milky-cloudy.

Layers that can be shone through can also be called diffuse, semitransparent, not image-preserving, scattering and/or referred to as “having a high haze value”. For example, these layers have in particular a haze value of at least 30 haze units and/or they are described as a layer with low clarity, thus one of 100% different, preferably less than 98%, in particular less than 95% and quite preferably less than 90%, of the clarity value.

In contrast, “transparent” describes a layer with high transmittance in the wavelength range of from 380 nm to 1400 nm, which is clear and preferably also image-preserving.

On the other hand, “opaque” denotes layers with low transmittance, but with high absorption in the wavelength range of from 380 nm to 1400 nm.

The invention makes it possible for the first time to perform an individualization of prefabricated laminates with functionality such as touch functionality of a touch sensor in an uncomplicated manner. This is achieved by supplementing a functional laminate with a laser protective layer between the electrical functional layer and a decorative layer which can be lasered with simple measures.

### LIST OF REFERENCE NUMBERS

1 laminate
2 electrical functional layer
3 decorative layer
4 laser protective layer
7 connecting material
10 transparent film
11 transparent substrate and/or carrier film
12 coating with scattering centers
13 carrying ply
14 superficial structuring
20 molding
21 region of the molding 20 that can be shone through
22 region of the molding 20 that cannot be shone through
23 part of the molding 20, e.g. film element
24 part of the molding 20, e.g. plastic component
25 user-facing surface of the molding 20
26 connection layer, e.g. adhesive and/or primer
27 frame element that cannot be shone through
28 detents with snap hooks
30 embodiment example 1, composite of laminate and molding
31 embodiment example 2, composite of laminate and molding
32 embodiment example 3, composite of laminate and molding
33 embodiment example 4, composite of laminate and molding
40 laser beam
41 uncovered region of the decorative layer 3
42 uncovered region of the decorative layer 3
43 movement direction of the laser beam 40
50 light source
51 LED
52 LED
53 electronics board with LEDs
54 light shaft
61 uncovered region of the decorative layer 3 and the connection layer 26
62 uncovered region of the decorative layer 3 and the connection layer 26

1-26. (canceled)

27. A laminate with at least one electrically conductive functional layer, a decorative layer and laser protective layer that can be shone through, wherein the laser protective layer is arranged between decorative layer and electrically conductive functional layer such that it adjoins the electrically conductive functional layer without colored varnish layer lying in between, wherein it protects the underlying layers of the laminate, from mechanical, physical and chemical environmental influences and from damage by laser radiation, wherein the laser protective layer is an optical scattering and/or diffusor layer and comprises light-scattering particles.

28. The laminate according to claim 27, wherein the laser protective layer has pores.

29. The laminate according to claim 27, wherein the laser protective layer has a layer thickness of between 0.5 and 500 μm.

30. The laminate according to claim 27, wherein the laser protective layer has a transmittance of at least 25%.

31. The laminate according to claim 27, wherein the laser protective layer that can be shone through deflects more than 30%, of the transmitted light, by more than 2.5° from the direction of the incident light beam.

32. The laminate according to claim 27, wherein the laser protective layer that can be shone through is dyed.

33. The laminate according to claim 27, wherein the laser protective layer that can be shone through is a layer of a carbon-based polymeric matrix material with particles and/or pores embedded therein.

34. The laminate according to claim 33, wherein the matrix material comprises monomers, oligomers, polymers and/or copolymers.

35. The laminate according to claim 27, wherein the decorative layer is formed opaque at least in regions and/or wherein the decorative layer has a transmittance of at most 50%.

36. The laminate according to claim 27, wherein the at least one decorative layer is dyed.

37. The laminate according to claim 27, wherein the at least one decorative layer comprises a monomer, oligomer and/or polymer.

38. The laminate according to claim 27, wherein the at least one decorative layer is a graphite and/or metal layer.

39. The laminate according to claim 27, wherein the at least one decorative layer comprises a polymeric matrix material with fillers.

40. The laminate according to claim 27, wherein the at least one electrical functional layer is an electrode layer.

41. The laminate according to claim 27, wherein the at least one electrical functional layer comprises thin metal layers.

42. The laminate according to claim 27, wherein the at least one electrical functional layer comprises at least one touch sensor panel.

43. A composite of the laminate according to claim 27 with a molding, wherein the laminate is arranged between a light source and the surface of the molding facing the observer.

44. The composite according to claim 43, in which the decorative layer of the laminate forms the layer of the laminate adjoining the molding.

45. The composite according to claim 43, in which the electrically conductive functional layer of the laminate forms the layer of the laminate adjoining the molding.

46. A method for producing a laminate according to claim 27, comprising at least one electrically conductive functional layer, at least one decorative layer and at least one laser protective layer, wherein the laser protective layer is arranged between decorative layer and electrically conductive functional layer and the method comprises the following steps:
a) providing an electrically conductive functional layer
b) applying at least one laser protective layer that can be shone through adjoining the electrically conductive functional layer without colored varnish layer lying in between,
c) applying at least one decorative layer to the laser protective layer, and
d) removing one or more regions of the decorative layer by means of lasers.

47. The method according to claim 46, wherein the method step d) of removing one or more regions of the decorative layer by means of lasers is effected partially.

48. The method according to claim 46, wherein a laser, is used in step d), which emits coherent light from the visible or infrared range.
